(19) United States
(12) Patent Application Publication
(10) Pub. No.: US 2013/0153448 A1
(43) Pub. Date: Jun. 20, 2013

(54) Medical Drug Solution Container

(71) Applicant: Katsuyuki Yoshikawa, Ichihara-shi (JP)

(72) Inventor: Katsuyuki Yoshikawa, Ichihara-shi (JP)

(73) Assignee: HOSOKAWA YOKO CO., LTD., Tokyo (JP)

(21) Appl. No.: 13/819,336

(22) PCT Filed: Aug. 25, 2011
(86) PCT No.: PCT/JP2011/069160

§ 371 Date: Feb. 26, 2013

(30) Foreign Application Priority Data
Aug. 27, 2010 (JP) 2010-191090

(51) Int. Cl. A61J 1/20

(52) U.S. Cl. CPC A61J 1/2093
USPC 206/219

(57) ABSTRACT

The present invention is a medical drug solution container (13) which is formed of a plastic film including seal layers. This medical drug solution container includes a plurality of drug solution storing chambers (15, 16) that are divided so as to be able to communicate; a spare discharge chamber (17) that is formed with a discharge port of a drug solution; liquid-tight dividing means (18) that liquid-tightly divides the plurality of drug solution storing chambers (15, 16) from each other; and non-liquid-tight dividing means (19) that non-liquid-tightly divides at least one (16) of the plurality of drug solution storing chambers (15, 16) from the spare discharge chamber (17), the non-liquid-tight dividing means (19) has fine pores (19a) through which a trace amount of the drug solution or water included in the drug solution can penetrate to the spare discharge chamber (17), and seals the seal layers so as to be peelable, and the seal layers includes one or more kinds of resins of which the melting point is 130° C. or higher and which is selected from a group consisting of homo-polypropylene, random-polypropylene, and high-density polyethylene.

### TECHNICAL FIELD

The present invention relates to a medical drug solution container that stores drug solutions, and particularly, a medical drug solution container that includes a plurality of divided drug solution storing chambers.

Priority is claimed on Japanese Patent Application No. 2010-191090, filed Aug. 27, 2010, the content of which is incorporated herein by reference.

### BACKGROUND ART

A medical drug solution container made of a plastic film, which is used for drip infusion, or the like by housing two or more kinds of medical drug solutions in drug solution storing chambers thereof each of which is individually divided and by causing partition walls partitioning the drug solution storing chambers so as to communicate with each other to mix drug solutions before use, has been known. Such medical drug solution containers are widely used owing to the merits of reducing medical errors preventing bacterial contamination caused by preparation of drug solutions, making the work of drug solution preparation efficient, and the like. However, in a real medical situation, an accident of forgetting communicating partition walls and thereby administering an incomplete drug solution to a patient occurs. In consideration of the circumstances above, a medical drug solution container, which is provided with a spare discharge chamber formed with a discharge port of a drug solution in addition to drug solution storing chambers in order to assuredly mix two or more kinds of drug solutions before use, has been proposed.

Patent Document 1 discloses a medical drug solution container which includes a plurality of drug solution storing chambers and a spare discharge chamber formed with a discharge port, and in which the plurality of drug solution storing chambers communicate with each other through a partition wall therebetween prior to a partition wall between the drug solution storing chamber and the spare discharge chamber when the drug solution storing chambers are pressed. According to this medical drug solution container, two or more kinds of drug solutions can be assuredly mixed before use.

Patent Document 2 also discloses a medical drug solution container in which drug solution storing chambers communicate with each other through a partition wall therebetween before the drug solution storing chamber and a spare discharge chamber communicate with each other through a partition wall therebetween when the drug solution storing chambers are pressed in the same manner. According to this medical drug solution container, two or more kinds of drug solutions can be assuredly mixed.

Drug solution bags obtained by putting drug solutions into drug solution storing chambers of such a medical drug solution container are provided for administration for patients after undergoing a heat sterilization process using high-temperature steam in order to assure an aseptic state in the drug solution storing chambers.

When the medical drug solution containers disclosed in Patent Documents 1 and 2 as above undergo a heat sterilization process, a bactericidal action is performed in this heat sterilization process since the drug solution storing chambers are filled with drug solutions. However, since a spare discharge chamber does not include water, or the like, there is a possibility that a bactericidal action is not sufficient in a heat sterilization process under the same condition as that in the drug solution storing chambers. For this reason, it is necessary to perform the same sterilization process as that in the drug solution storing chambers by being filled with an extremely small amount of water separately, or to perform sterilization with a radiation process using electron beams, y-rays, or the like, or a chemical process using ethylene oxide gas, formaldehyde gas, or the like, for the spare discharge chamber, different from the heat sterilization of the drug solution storing chambers. As a result, the production process of the drug solution bag becomes complicated, which leads to an increase in production cost.

With regard to this problem, Patent Document 3 discloses that, in a medical drug solution container in which a middle chamber corresponding to the above-described spare discharge chamber is formed, a communication passage through which gas passes but liquid does not is formed as an unsealed portion in a weak seal portion partitioning the middle chamber and a storing chamber storing a drug solution. According to this medical drug solution container, since the middle chamber and the storing chamber communicate with each other via the communication passage, during a heat sterilization process after a drug solution is stored, the middle chamber is filled with steam flowing out from the storing chamber, which enables sufficient sterilization.

However, this communication passage is formed as an unsealed portion that is fine to the extent that gas can pass therethrough but liquid does not pass. For this reason, films of unsealed portions are not sealed, but come into substantial contact with each other. For this reason, when a drug solution bag using this medical drug solution container undergoes a heat sterilization process, there is a possibility that the films of the unsealed portions coming into contact with each other stick to each other due to heating during the heat sterilization process. As the films of the unsealed portions stick to each other as above, the communication passage is occluded, and thus, steam does not flow into the middle chamber. Even if steam flows into the middle chamber, the amount thereof is very small, and thus a bactericidal effect in the middle chamber is not sufficient.

Further, Patent Document 4 discloses a medical drug solution container in which a trace amount of a drug solution or water included in the drug solution penetrates from a drug solution storing chamber to a spare discharge chamber through fine pores formed in a sealed portion between the drug solution storing chamber and the spare discharge chamber as an unsealed portion. The fine pores of this medical drug solution container are formed so as to make a trace amount of liquid penetrate therethrough. For this reason, after a drug solution is stored in the drug solution storing chambers, a trace amount of the drug solution or water included in the drug solution exists in the spare discharge chamber and the fine pores even before a heat sterilization process. As a result, even when a drug solution bag using this medical drug solution container is heated during the heat sterilization process, sticking of films of unsealed portions is prevented owing to the drug solution or water existing in the fine pores. On the other hand, the drug solution or water that is already present in the spare discharge chamber evaporates and the drug solution or water that penetrated through the fine pores from the drug solution storing chambers also evaporates so as to spread therein. For this reason, according to the medical drug solution container of Patent Document 4, a heat sterilization can be performed for the spare discharge chamber when a sufficient amount of the drug solution or water exists, and an aseptic state of the spare discharge chamber can be secured also with a heat sterilization process under the same conditions as those of the drug solution storing chambers.

### CITATION LIST

### Patent Document

[Patent Document 1] Japanese Unexamined Patent Application, First Publication No. H9-327498

[Patent Document 2] Japanese Unexamined Patent Application, First Publication No. 2002-136570

[Patent Document 3] Published Japanese Translation No. 2006-507914 of the PCT International Publication

[Patent Document 4] Japanese Unexamined Patent Application, First Publication No. 2005-342174

### SUMMARY OF INVENTION

### Technical Problem

However, when a medical drug solution container disclosed in Patent Document 4 is filled with drug solutions and then a heat sterilization process is performed under a condition of an extremely high temperature of 121° C. or higher, there is a possibility that a spare discharge chamber cannot be processed to be the same aseptic state as in a drug solution storing chamber. As a result of close review by the present inventor, it is ascertained that, when a heat sterilization process is performed under a condition of a more extremely high temperature, films of unsealed portions stick to each other due to heating during the heat sterilization process, which results in occlusion of fine pores, even if the fine pores are formed such that a trace amount of liquid can penetrate therethrough, whereby the aseptic state of the spare discharge chamber is insufficient.

An object of the present invention is to provide a medical drug solution container that can secure an aseptic state of a spare discharge chamber to the same degree as that of drug solution storing chambers even when a heat sterilization process is performed under a condition of a more extremely high temperature.

### Solution to Problem

In order to solve the above problems, the present invention proposes the following means. A medical drug solution container of the present invention is formed of a plastic film including seal layers. This medical drug solution container includes a plurality of drug solution storing chambers that are divided so as to be able to communicate; a spare discharge chamber that is formed with a discharge port of a drug solution; liquid-tight dividing member that liquid-tightly divides the plurality of drug solution storing chambers from each other; and non-liquid-tight dividing member that non-liquid-tightly divides at least one of the plurality of drug solution storing chambers from the spare discharge chamber. The non-liquid-tight dividing member has fine pores through which a trace amount of the drug solution or water included in the drug solution can penetrate the spare discharge chamber, and seals the seal layers so as to be separable. The seal layers include one or more kinds of resins of which the melting point is 130° C. or higher and which is selected from a group consisting of homo-polypropylene, random-polypropylene, and high-density polyethylene. Note that the “can penetrate” in the present invention includes the meaning that a drug solution or water included in the drug solution can leak in a liquid state. The non-liquid-tight dividing member is preferably not put in a communication state under a pressure rise of the drug solution storing chambers at which the liquid-tight dividing member starts to cause communication. The high-density polyethylene preferably has density of 0.940 g/cm³ or higher, and the ratio of a mass average molecular weight Mw to a number average molecular weight Mn (Mw/Mn) is 4.5 or lower.

### Advantageous Effects of Invention

A medical drug solution container of the present invention can secure an aseptic state of a spare discharge chamber to the same degree as that of a drug solution storing chamber even when a heat sterilization process is performed under a condition of a more extremely high temperature.

### BRIEF DESCRIPTION OF DRAWINGS

FIG. 1 is a perspective external appearance diagram showing a drug solution bag of which a medical drug solution container of the present invention is filled with a medical drug solution.

FIG. 2A is an illustrative diagram showing a use process of the drug solution bag shown in FIG. 1.

FIG. 2B is an illustrative diagram showing a use process of the drug solution bag shown in FIG. 1.

FIG. 2C is an illustrative diagram showing a use process of the drug solution bag shown in FIG. 1.

FIG. 3 is an illustrative diagram describing an action of the medical drug solution container of the present invention.

FIG. 4 is an illustrative diagram showing another embodiment of the medical drug solution container of the present invention.

### DESCRIPTION OF EMBODIMENTS

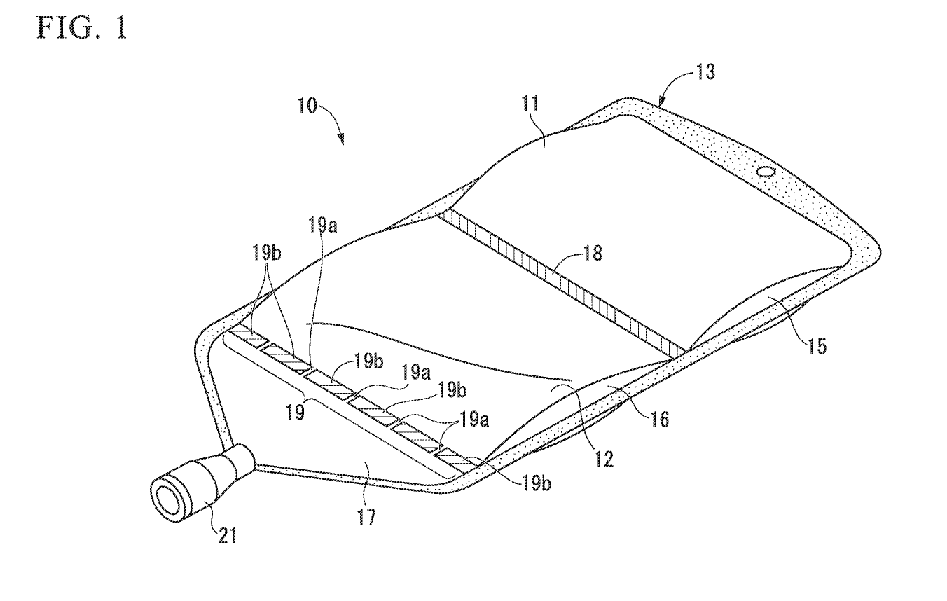

Hereinafter, embodiments of the present invention will be described with reference to drawings. FIG. 1 is a perspective external appearance diagram showing an embodiment of a drug solution bag of which a medical drug solution container of the present invention is filled with a medical drug solution. A drug solution bag 10 of the present embodiment has two kinds of drug solutions of a first drug solution 11 and a second drug solution 12, and a medical drug solution container 13 that divides and stores the drug solutions 11 and 12.

The medical drug solution container 13 is formed of a plastic film including seal layers, and specifically, formed such that the circumferential portion of the plastic film of which the seal layers face inwardly is sealed so as not to be peelable. In addition, the medical drug solution container 13 is divided to have three chambers of a first drug solution storing chamber 15, a second drug solution storing chamber 16, and a spare discharge chamber 17, and the first drug solution storing chamber 15 houses the first drug solution 11, and the second drug solution storing chamber 16 houses the second drug solution 12, respectively.

The first drug solution storing chamber 15 and the second drug solution storing chamber 16 are partitioned by a liquid-tight seal (liquid-tight dividing member) 18 that is liquid-tight dividing member that is peeled so as to communicate with the chambers. The liquid-tight seal 18 is peeled by pressing the first drug solution storing chamber 15 or the second drug solution storing chamber 16 so as to increase the internal pressure of the first drug solution storing chamber 15 or the second drug solution storing chamber 16. With this peeling, the first drug solution storing chamber 15 and the second drug solution storing chamber 16 are unified, and the first drug solution 11 and the second drug solution 12 stored in the first drug solution storing chamber 15 and the second drug solution storing chamber 16 respectively are mixed.

On the other hand, the second drug solution storing chamber 16 and the spare discharge chamber 17 are divided by a non-liquid-tight seal (non-liquid-tight dividing member) 19 that is non-liquid-tight dividing member. The non-liquid-tight seal 19 has fine pores 19a through which a trace amount of a drug solution or water included in the drug solution penetrates into the spare discharge chamber 16, and is sealed so that seal layers of the plastic film can be peeled. The fine pore 19a corresponds to an unsealed portion when the non-liquid-tight seal 19 is formed, and is formed so as to pass through the second drug solution storing chamber 16 and the spare discharge chamber 17. In the present embodiment, five fine pores 19a are formed. In addition, portions other than the fine pores 19a on the non-liquid-tight seal 19 are defined to be sealed portions 19b that can be peeled. Note that, the number of the fine pores 19a may be one or more, and the number can be appropriately set. In addition, the fine pores 19a may be blocked by a material having a liquid-penetrating or water-penetrating property so long as the function thereof is not depressed.

A discharge port 21 is formed in the spare discharge chamber 17. This discharge port 21 is an outlet from which a mixed drug solution obtained by mixing the first drug solution 11 and the second drug solution 12 is ejected. The mixed drug solution is ejected through the outlet from the medical drug solution container 13 by connecting a discharge member such as a dedicated adaptor, or a needle thereto. In addition, the discharge port may be used as an inlet for incorporating other drug solutions into the mixed drug solution.

At a time of using this drug solution bag 10, by first pressing the first drug solution storing chamber 15 or the second drug solution storing chamber 16, the liquid-tight seal 18 is peeled, and the first drug solution storing chamber 15 and the second drug solution storing chamber 16 communicate with each other. Further, by pressing the chamber formed by the communication of the first drug solution storing chamber 15 and the second drug solution storing chamber 16, the non-liquid-tight seal 19 is peeled so as to communicate. In order to realize this action, the liquid-tight seal 18 is formed so as to be peeled under a lower pressure rise than the non-liquid-tight seal 19, and the non-liquid-tight seal 19 is formed so as not to be peeled under the internal pressure at which the liquid-tight seal 18 is peeled causing the communication to start.

As a method of adjusting such sealing strength of the liquid-tight seal 18 and the non-liquid-tight seal 19, for example, there are methods in which heat sealing temperatures of the liquid-tight seal 18 and the non-liquid-tight seal 19 are adjusted, or seal bars having seal surfaces of different shapes are used. In addition, it is preferable to use, only for a portion formed as the liquid-tight seal 18, a method in which a flexible material that is cross-linked by changing the degree of cross-linking in advance using electron beams is used, or the like, or in which resin tapes having different peeling property are inserted between facing plastic films.

A single-layered film that is constituted only by a seal layer, or a multi-layered film that is constituted by two or more layers including a seal layer on the side of the inward face (liquid-contacting face) of the medical drug solution container 13 and an outer layer on the side of outward face is used as a plastic film used as the material of the medical drug solution container 13. One or more kinds of resin of which the melting point is 130° C. or higher and which is selected from a group consisting of homo-polypropylene, random-polypropylene, and high-density polyethylene are used as a material composing the seal layer. If such a resin composes the seal layer, even when a heat sterilization process is performed for the drug solution bag 10 under a condition of an extremely high temperature (121° C. or higher), the fine pores 19a will not be occluded. For this reason, the effect of the heat sterilization process can be maintained, and the aseptic state of the spare discharge chamber 17 and the discharge port 21 that communicates therewith can be sufficiently secured to the same level of those of the drug solution storing chambers 15 and 16. Note that, the melting point is based on JIS K 7121, and is a value measured in a unit of the rate of a temperature increase of 10° C. per minute using differential scanning calorimetry (DSC). Specifically, when the material is high-density polyethylene, 2 to 3 mg of a sample thereof is precisely weighted, and retained for 5 minutes at 40° C. under a nitrogen atmosphere. Then, the temperature is raised at the rate of a temperature increase of 10° C./minute, and after the temperature reaches 160° C., the sample is retained for 5 minutes. Then, the temperature is lowered at the rate of a temperature decrease of 10° C./minute, and after the temperature reaches 40° C., the sample is retained for another 5 minutes. Then, the temperature is raised up to 160° C. at the rate of a temperature increase of 10° C./minute again. The temperature at the endothermic peak appearing in this final process is measured, and then, the temperature is set to be the melting point. Note that, when the material is homo-polyplene and random-polyplene, the melting point is obtained in the same manner except that 160° C. is changed to 180° C.

In other words, if a resin having a rubber portion such as block-polypropylene is used as a material composing the seal layer, and the drug solution bag undergoes a heat sterilization process under a high temperature of 121° C. or higher, the seal layers facing each other in the unsealed portion where fine pores stick to each other due to the rubber portion of the block-polypropylene, and accordingly, the fine pore is occluded. As a result, the drug solution or water in an amount required for heat sterilization does not spread into the spare discharge chamber and the discharge port, and even when a heat sterilization process is performed for the spare discharge chamber and the discharge port under the same condition as that of the drug solution storing chamber, a sufficient aseptic state cannot be secured. In such a case, it is necessary to additionally perform a process such as a radiation process, a chemical sterilization process, or the like only for the spare discharge chamber and the discharge port, which increases production cost of the drug solution bag. In addition, even if the resin is selected from a group consisting of homo-polypropylene, random-polypropylene, and high-density polyethylene, when the seal layer is formed using a resin having a melting point lower than 130° C., the seal layers facing in the unsealed portion are softened and then stick to each other during a heat sterilization process at a high temperature of 121° C. or higher. As a result, the fine pore is occluded, and even when a heat sterilization process is performed for the spare discharge chamber and the discharge port under the same condition as that of the drug solution storing chamber, a sufficient aseptic state cannot be secured.

On the other hand, when the seal layer is formed of one or more kinds of resin of which the melting point is 130° C. or higher and which is selected from a group consisting of homo-polypropylene, random-polypropylene, and high-density polyethylene, deterioration of transparency of a plastic film derived from a heat sterilization process is easily prevented. Particularly, when the high-density polyethylene is used, if the seal layer is formed using high-density polyethylene of which the density is 0.940 g/cm³ or higher, and the ratio of a mass average molecular weight Mw to a number average molecular weight Mn (Mw/Mn) is 4.5 or lower, not only are the fine pores 19a not occluded, but also transparency of a plastic film does not deteriorate easily during a heat sterilization process under a high temperature.

When a multi-layered film is used as a plastic film, the outer layer may be one layer or two or more layers, a material thereof is used with no particular limit if it is a resin used in the field of medical containers. Specifically, for example, a polyolefin resin, a polyamide resin, a polyester resin, a (meta)acryl resin, a vinyl chloride resin, a vinylidene chloride resin, polyethersulfone, an ethylene-vinylalcohol copolymer, and the like can be exemplified. Among these, a polyolefin resin that is excellent in transparency, flexibility, and hygiene, and also inexpensive is preferable. As a polyolefin resin, for example, a polyethylene-based resin such as high-density polyethylene, medium-density polyethylene, high pressure-method low-density polyethylene, linear low-density polyethylene resin, or an ethylene-vinyl acetate copolymer, an olefin-based elastomer such as an ethylene-a olefin random copolymer, or the like, a polypropylene-based resin such as a polypropylene, an ethylene-propylene random copolymer, an α-olefin-propylene random copolymer, a cyclic polyolefin resin, a single-layered and multi-layered film of a mixture including the above resins, and the like can be exemplified. A portion of such a resin may be cross-linked for the purpose of improvements in thermal resistance, or the like.

When the plastic film is a single-layered film, the thickness is preferably 50 to 1000 μm. In a case of a multi-layered film, the thickness of a seal layer is preferably 3 to 100 μm, and the thickness of the entire multi-layered film is preferably 50 to 1000 μm, and more preferably 100 to 500 μm. In addition, as a method of producing the plastic film, a film production method of the related art such as a T-die molding method, an air-cooled blown film process, a water-cooled blown film process, or the like can be applicable.

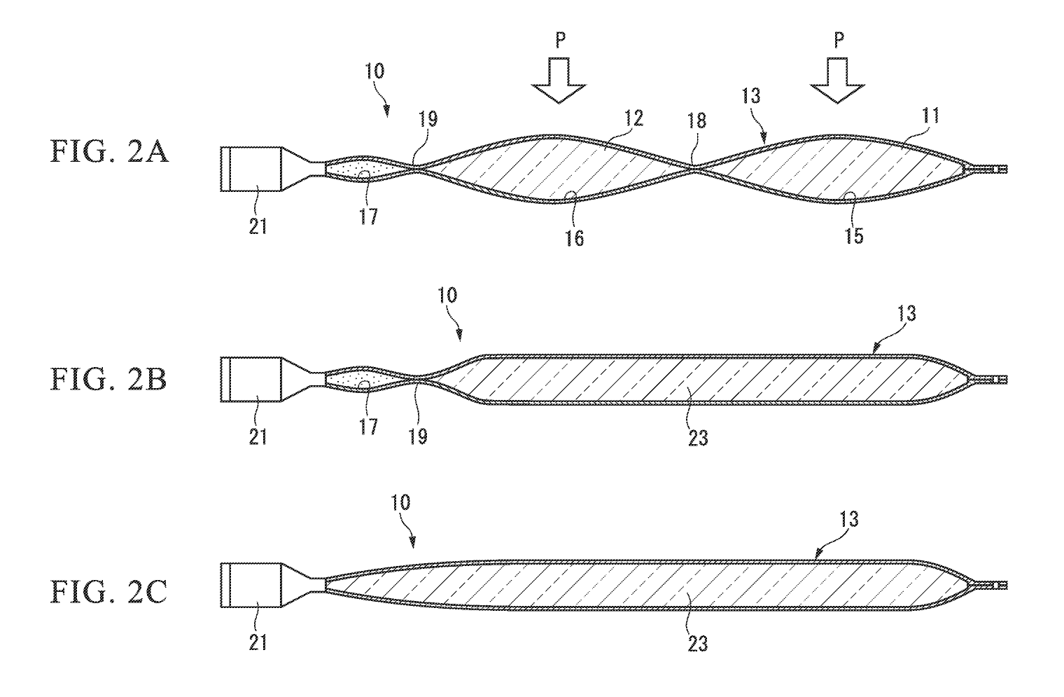

When the drug solution bag 10 is to be used, the first drug solution storing chamber 15 or the second drug solution storing chamber 16 are pressed in the directions indicated by the arrows P so as to increase the pressure of the first drug solution storing chamber 15 or the second drug solution storing chamber 16 as shown in FIG. 2A. As a result, the liquid-tight seal 18 that is supposed to be peeled under a lower pressure rise than the non-liquid-tight seal 19 is peeled before the non-liquid-tight seal 19 is peeled so as to unify the first drug solution storing chamber 15 and the second drug solution storing chamber 16. Accordingly, a mixed drug solution 23 is prepared as shown in FIG. 2B. When the drug solution bag 10 is further pressed, the non-liquid-tight seal 19 is peeled, and thereby the mixed drug solution 23 flows also into the spare discharge chamber 17 so as to make a state in which the mixed drug solution 23 can be emitted from the discharge port 21, as shown in FIG. 2C.

Since the liquid-tight seal 18 is formed to be peeled under a lower pressure rise than the non-liquid-tight seal 19 in this drug solution bag 10, it is reliably prevented that only the second drug solution 12 is emitted from the discharge port 21 after the non-liquid-tight seal 19 is first peeled in the state in which the liquid-tight seal 18 is not peeled.

In addition, even if discharge member of a drug solution is connected to the discharge port 21 without peeling the liquid-tight seal 18 or the non-liquid-tight seal 19, the amount of the drug solution is trivial even when the drug solution is discharged because only a trace amount of the drug solution is present in the spare discharge chamber 17. Thus, a substantial amount of the drug solution will not be discharged from the discharge means. In addition, at the time of starting the use of the drug solution bag 10, a user generally adjusts the speed of discharge. Because this discharge speed adjustment is not possible only with the trace amount of the drug solution present inside the spare discharge chamber 17 and the discharge port 21, the user can notice non-separation of the non-liquid-tight seal 19 at the time when the discharge speed adjustment is performed. Further, when the drug solution bag 10 is provided for administration to a patient, the bag is generally suspended so that the discharge port 21 faces downward. At this moment, the drug solution bag in which a mixed drug solution is prepared by communication of each chamber has an appearance in which the periphery of the discharge port 21 in the lower part has a swollen shape. On the other hand, the drug solution bag in which the spare discharge chamber 17 does not communicate with other chamber has an appearance in which the periphery of the discharge port 21 has a thin flat shape since an extremely small amount of the drug solution is included in the spare discharge chamber 17. Therefore, the user can easily notice non-peeling of the non-liquid-tight seal 19 from the appearance at the time when the drug solution bag 10 is suspended as above.

The medical drug solution container 13 can call the user's attention to the fact that the liquid-tight seal 18 or the non-liquid-tight seal 19 is not peeled before it is actually used. Thus, occurrence of an incident in which only the second drug solution 12 is emitted from the discharge port 21 can be reliably prevented.

In addition, in the medical drug solution container 13, the fine pores 19a, through which a trace amount of the drug solution or water included in the drug solution can penetrate to the spare discharge chamber 17, are formed in the non-liquid-tight seal 19 between the second drug solution storing chamber 16 and the spare discharge chamber 17. For this reason, when a heat sterilization process is performed for the drug solution bag 10 formed by filling the medical drug solution container 13 with drug solutions, the inner portions of the spare discharge chamber 17 and the discharge port 21 reach saturated water vapor pressure due to the second drug solution 12a and water thereof of which a tract amount of a portion already flows into the spare discharge chamber 17, and a liquid, the second drug solution 12a in a vapor state, or water thereof which further flow into the spare discharge chamber 17 via the fine pores 19a. As a result, it is possible to set the level at which the aseptic state of the spare discharge chamber 17 and the discharge port 21 is guaranteed to be the same as that of the drug solution storing chambers 15 and 16.

Particularly, since the seal layer of the medical drug solution container 13 is formed of the plastic film including the above-described resins, even when a heat sterilization process is performed under a condition of a high temperature of 121° C. or higher, the fine pores 19a are not occluded due to the heating at the time. Thus, the drug solution or water of a sufficient amount for heat sterilization spreads into the spare discharge chamber 17 and the discharge port 21. As a result, a satisfactory aseptic state is guaranteed for the spare discharge chamber 17 and the discharge port 21 by the heat sterilization process performed under the same condition as that of the drug solution storing chambers 15 and 16. In this case, since it is not necessary to additionally perform a process such as a radiation process, or a chemical sterilization process only for the spare discharge chamber 17 and the discharge port 21, the production cost of the drug solution bag 10 can be suppressed. In addition, it is possible to ensure an aseptic state of the entire drug solution bag 10.

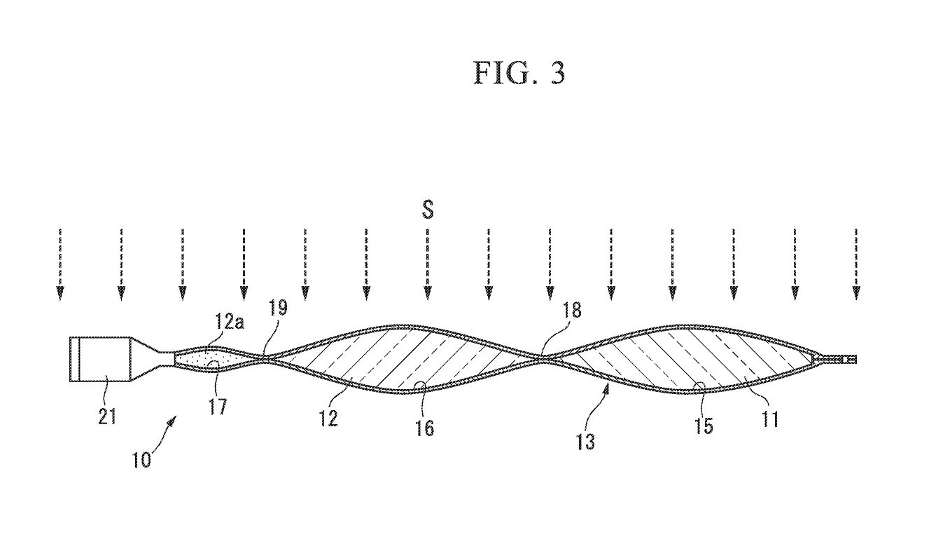

A heat sterilization process is implemented by heating the bag to a sterilization temperature using, for example, high-pressure steam S, as shown in FIG. 3. Such high pressure steam sterilization is performed such that, for example, the drug solution bag 10 is stored in a pressure vessel and pressurized, and then the drug solution bag 10 is left in a warm-water bath, a warm-water shower, or in steam for a predetermined time.

The trace amount of liquid penetrating from the non-liquid-tight seal 19 to the spare discharge chamber 17 is an amount of water that is supposed to be present in the spare discharge chamber 17 and the discharge port 21 and is necessary and sufficient for setting a state in which the spare discharge chamber 17 and the discharge port 21 can undergo effective heat sterilization by being filled with saturated water vapor at the highest temperature during a heat sterilization process.

Specifically, quantification of the amount of water can be performed using saturated water vapor pressure obtained from “Appendix Table 1.1: Saturated water vapor pressure” and a formula (dv=e·Mᵥ·RT) converting water vapor pressure e into absolute humidity dᵥ in “Commentary of Appendix Table 1: A quantitative conversion formula indicating humidity” described in “Humidity—Measurement Methods” of JIS Z 8806. When an assumed highest temperature of heat sterilization is set to be 130.0° C., and calculation is performed based on saturated water vapor pressure eₛ=270.3 kPa obtained from the Appendix Table 1.1 described above, if a medicament including water of about 2 mg/cm³, i.e. 2 μL/cm³ per space quantity is present in the inner space including the spare discharge chamber 17 and the discharge port 21, an aseptic state is calculated to be secured during a heat sterilization process. However, absolute temperature T (t/° C.=T/K−273.15), a gas constant R=8.314472 J·K⁻¹·mol⁻¹, and a molar mass of water Mᵥ=18.01528 kg/mol which are similarly defined in JIS Z 8806 to the conversion formula of the Commentary of Appendix Table 1 are used. More specifically, when the space quantity of the spare discharge chamber 17 is set to be 30 cm³, the necessary water amount is about 60 μL. Since one drop in an infusion is presumed to be about 60 μL, the space of the spare discharge chamber 17 and the discharge port 21 is considered to be filled with saturated water vapor during heat sterilization with the amount of water of about one drop of a medicament. In addition, since the space quantity of the spare discharge chamber 17 has a maximum of 120 cm³, 4 or more drops is sufficient for the spare discharge chamber 17 during heat sterilization.

In addition, the upper limit of the leakage rate (penetration rate) of the trace amount of liquid in the non-liquid-tight seal 19 is set to be less than an administration amount per hour when a mixed drug solution is administered to a patient. On the other hand, the lower limit thereof is, under conditions of a heat sterilization process for which an aseptic state of the first drug solution storing chamber 15 and the second drug solution storing chamber 16 is assured, a lowest leakage rate at which a liquid amount necessary for the spare discharge chamber 17 and the discharge port 21 to reach the same aseptic state assurance level is obtained, or a lowest leakage rate at which a liquid amount necessary for the spare discharge chamber 17 and the discharge port 21 to reach the aseptic state assurance level of 10⁻⁶ or lower is obtained. This aseptic state assurance level of 10⁻⁶ or lower is set by the International Standards Organization.

Note that the assurance of an aseptic state can be defined using the method described in “Section 11. Final Sterilization Method and Sterilization Indicator of the 15^{th} Amendment Reference Information of Japanese Pharmacopoeia”. Specifically, the same method as one for verifying assurance of an aseptic state of a drug solution can be employed. As an example of an evaluation method, for example, when an overkill method is employed, a paper strip type biological indicator including the given number of bacteria ATCC 7953 of Geobacillusstearothermophilus of which a D value (a sterilization processing unit necessary for setting the initial number of bacteria to be 1/10) is one or higher and which is used as a sterilization indicator, and the indicator is placed in the spare discharge chamber 17. When the spare discharge chamber 17 is large, a plurality of the biological indicators are placed in a distributed manner if necessary. As locations when the plurality of the biological indicators are placed, for example, each corner and the center of the spare discharge chamber 17, the inside of the discharge port 21, and the like can be listed. It is important to ensure sterilization also in cold spots that are portions in the spare discharge chamber 17 which are difficult for saturated water vapor to reach during autoclaved sterilization. In this state, autoclaved sterilization is performed under the condition of assuring the aseptic states of the drug solution storing chambers 15 and 16, and by how much the number of bacteria included in the above-described biological indicators is reduced is examined. If the number is reduced by the power of 12, 10⁻⁶ or lower as the aseptic state assurance level is obtained.

A leakage rate at which this aseptic state assurance level is obtained is, for example, 0.12 mL/minute or lower, preferably 0.06 mL/minute or lower, and more preferably 0.012 mL/minute or lower. When a medicament is leaked at a leakage rate described above, even if drip infusion is performed while forgetting normal communication of each chamber due to any possibility, the drip rate of the infusion is merely 1 to 2 drops for one minute. This drip rate is impossible in normal drip infusion. Thus, a user can easily notice that mixture of drug solutions resulting from normal communication is not performed at the moment.

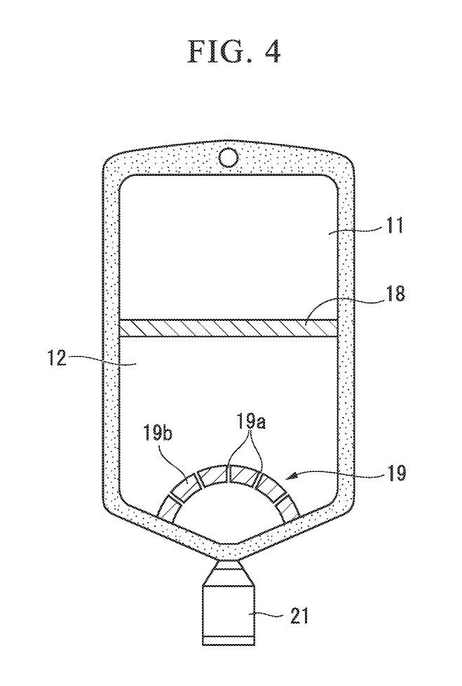

Note that, in the example described above, the non-liquid-tight seal 19 dividing the second drug solution storing chamber 16 and the spare discharge chamber 17 is formed in a linear shape so as to transverse the medical drug solution container 13 in the width direction. However, as shown in FIG. 4, for example, the non-liquid-tight seal 19 may be formed in a curved shape so as to surround the base end portion of the discharge port 21. In addition, the number of drug solution storing chambers may be three or more, not being limited to two. In addition, in the example described above, the non-liquid-tight seal 19 is formed so as not to be in a communicating state with a pressure rise of the drug solution storing chambers at which the liquid-tight seal 18 starts to cause communication. However, when the volume of the second drug solution storing chamber 17 adjacent to the spare discharge chamber 17 is formed to be smaller than that of the first drug solution storing chamber 15 due to the combination of the drug solutions, it may be configured that the liquid-tight seal 18 is peeled by a pressure rise exerted when the first drug solution storing chamber 15 is pressed, and the non-liquid-tight seal 19 is also peeled substantially at the same time of the peeling of the liquid-tight seal 18. In such a case, it is not necessary for the non-liquid-tight seal 19 not to be in a communication state by the pressure rise of the drug solution storing chambers at which the liquid-tight seal 18 starts to cause communication.

### EXAMPLES

Hereinafter, the present invention will be described in detail using examples, but the present invention will not be limited to the examples.

### Examples 1 and 3

A medical drug solution container was produced using a three-layered co-extruded film, which includes a seal layer which is composed of a resin shown in Table 1 and has a thickness of 15 μm, as a plastic film. Each of the drug solution storing chambers of this medical drug solution container was filled with 500 ml of purified water, and 40 drug solution bags 10 as shown in FIG. 1 were produced for each example. Note that the three-layered co-extruded film is a film composed of three layers formed in such a way that, on the outer side of the layer coming into contact with the seal layer described above, a layer having a thickness of 220 μm, which is composed of linear low-density polyethylene (density of 0.902 g/cm³, and a melt flow rate (MFR) of 1.2 g/10 minutes) and made by Japan Polyethylene Corporation is formed, and on the outer side of this layer, a layer having a thickness of 15 μm, which is composed of the same resin as the seal layer, is formed. In addition, in the non-liquid-tight seal 19, five unsealed portions having a width of 6 mm were formed as the fine pores 19a.

Next, autoclaved sterilization was performed for 20 out of the 40 drug solution bags 10 under the condition of a temperature of 105° C. for 30 minutes, and autoclave sterilization was performed for the remaining 20 drug solution bags 10 under the condition of a temperature of 121° C. for 30 minutes. Then, whether or not water drops are present in the spare discharge chamber 17 of the drug solution bags 10 after the sterilization was visually checked. Note that, before the sterilization, that no water drops were preset in the spare discharge chamber 17 of the drug solution bags 10 visually checked in advance. In addition, haze values of the drug solution bags 10 after the sterilization were measured according to JIS K-7136. The results are shown in Table 1.

### Example 2 and Comparative Examples 1 and 2

Drug solution bags 10 were produced in the same manner as in Example 1 and autoclave sterilization was performed except that a single-layered film having a thickness of 250 μm including a resin shown in Table 1 is used as a plastic film. Then, in the same manner as in Example 1, whether or not water drops are present in the spare discharge chamber 17 of the drug solution bags 10 after sterilization was visually checked, and haze values were measured. The results are shown in Table 1. The melting points in Table 1 are based on JIS K 7121, and are values measured by setting the rate of temperature increase is 10° C. per minute using the differential scanning calorimetry (DSC).

TABLE 1

| | | | | The number of |
|---|---|---|---|---|
| | | | | drug solution bags |
| | | | | in which water |
| | | | | drops in spare |
| | | Temperature | | discharge chamber |
| | | of | | can be visually |
| | Resin | Sterilization | Haze (%) | checked |
| Example 1 | Resin 1 | 121° C. | 20 | 20/20 |
| | | 105° C. | 16 | 20/20 |
| Example 2 | Resin 2 | 121° C. | 8 | 20/20 |
| | | 105° C. | 8 | 20/20 |
| Example 3 | Resin 3 | 121° C. | 34 | 20/20 |
| | | 105° C. | 28 | 20/20 |
| Comparative | Resin 4 | 121° C. | 15 | 16/20 |
| Example 1 | | 105° C. | 12 | 20/20 |
| Comparative | Resin 5 | 121° C. | 8 | 2/20 |
| Example 2 | | 105° C. | 8 | 7/20 |

Hereinafter, the present invention will be described in detail using examples, but the present invention will not be limited to the examples.

### Examples 1 and 3

Resin 1: High-density polyethylene (“NOVATEC (trade name)” made by Japan Polyethylene Corporation, density of 0.956 g/cm³, Mw/Mn=4.3, melting point of 135° C.), Resin 2: random-polyprophylene (“ZEALOUS (trade name)” made by Mitsubishi Chemical Corporation, melting point of 134° C.), Resin 3: High-density polyethylene (“NOVATEC (trade name)” made by Japan Polyethylene Corporation, density of 0.953 g/cm³, Mw/Mn=5.9, melting point of 132° C.), Resin 4: Linear low-density polyethylene (“MORETEC (trade name)” made by Prime Polymer Co., Ltd., density of 0.923 g/cm³, melting point of 115° C.), and Resin 5: Block polyprophylene (“ZEALOUS (trade name)” made by Mitsubishi Chemical Corporation, melting point of 157° C.),

In each of the examples, water drops could be visually found in the spare discharge chambers of all 20 drug solution bags (described as 20/20 in the table) even after a heat sterilization process of 121° C. On the other hand, it was ascertained that aseptic states of the spare discharge chamber 17 and the discharge port 21 that communicates therewith can be sufficiently secured without causing occlusion of the fine pores 19a even in heat sterilization processes of high temperatures. On the other hand, in the case of the drug solution bags of Comparative Example 1, water drops could be visually found in the spare discharge chambers of all 20 drug solution bags in the heat sterilization process of 105° C. However, in the heat sterilization process of 121° C., water drops were found in only 16 bags. On the other hand, it was ascertained that there is a possibility of aseptic states of the spare discharge chamber 17 and the discharge port 21 that communicates therewith to be not sufficiently secured causing occlusion of the fine pores 19a in heat sterilization processes of high temperatures. In addition, in the case of drug solution bags of Comparative Example 2, it was ascertained that there is a possibility of aseptic states of the spare discharge chamber 17 and the discharge port 21 that communicates therewith to be not sufficiently secured in the heat sterilization processes of both 105° C. and 121° C.

### INDUSTRIAL APPLICABILITY

According to the medical drug solution container of the present invention, an aseptic state of the spare discharge chamber can be secured to the same level of the drug solution storing chambers even when a heat sterilization process is performed under a condition of a far extremely high temperature.

### REFERENCE SIGNS LIST

10 drug solution bag

11 first drug solution

12 second drug solution

13 medical drug solution container

14 first drug solution storing chamber

15 second drug solution storing chamber

16 spare discharge chamber

17 liquid-tight seal (liquid-tight dividing means)

18 non-liquid-tight seal (non-liquid-tight dividing means)

19a fine pore

19b sealed portion

21 discharge port

1. A medical drug solution container which is formed of a plastic film including seal layers, comprising:
a plurality of drug solution storing chambers that are divided so as to be able to communicate;
a spare discharge chamber that is formed with a discharge port of a drug solution;
liquid-tight dividing means that liquid-tightly divides the plurality of drug solution storing chambers from each other; and
non-liquid-tight dividing means that non-liquid-tightly divides at least one of the plurality of drug solution storing chambers from the spare discharge chamber,
wherein the non-liquid-tight dividing means has fine pores through which a trace amount of the drug solution or water included in the drug solution can penetrate to the spare discharge chamber, and seals the seal layers so as to be peelable, and
wherein the seal layers includes one or more kinds of resins of which the melting point is 130° C. or higher and which is selected from a group consisting of homo-polypropylene, random-polypropylene, and high-density polyethylene.

2. The medical drug solution container according to claim 1, wherein the non-liquid-tight dividing means is not put in a communication state under a pressure rise of the drug solution storing chambers at which the liquid-tight dividing means starts to cause communication.

3. The medical drug solution container according to claim 1, wherein the high-density polyethylene has density of 0.940 g/cm³ or higher, and the ratio of a mass average molecular weight Mw to a number average molecular weight Mn (Mw/Mn) is 4.5 or lower.

4. The medical drug solution container according to claim 2 wherein the high-density polyethylene has density of 0.940 g/cm3 or higher, and the ratio of a mass average molecular weight Mw to a number average molecular weight Mn (Mw/Mn) is 4.5; or lower.
